(19) United States
(12) Patent Application Publication
(10) Pub. No.: US 2003/0123555 A1
(43) Pub. Date: Jul. 3, 2003

(54) Video decoding system and memory interface apparatus

(76) Inventor: Eung Tae Kim, Suwon (KR)

Correspondence Address: HARNESS, DICKEY & PIERCE, P.L.C., P.O. BOX 8910, RESTON, VA, 20195, US

(21) Appl. No.: 10/329,701

(22) Filed: Dec. 27, 2002

(30) Foreign Application Priority Data
Dec. 29, 2001 (KR) P 2001-87766

(51) Int. Cl. G06K 9/36; G06K 9/46; H04N 7/12

(52) U.S. Cl. 375/240.25; 382/236; 375/240.26

(57) ABSTRACT

A video decoding system and a memory interface thereof are disclosed, in which Y, Cb and Cr data of one macro block is rearranged to be simultaneously stored in an external memory and to be simultaneously read from the external memory, when storing video decoded data in the external memory, and outputting the stored data for motion compensation with a data bus of 96 bits, thereby decreasing an entire bandwidth of a video decoder and a local processing time.

This application claims the benefit of Korean Application No. P2001-87766, filed on Dec. 29, 2001, which is hereby incorporated by reference as if fully set forth herein.

### BACKGROUND OF THE INVENTION

1. Field of the Invention

The present invention relates to a Moving Picture Experts Group (MPEG)-2 video decoding system and a memory interface apparatus of the video decoding system for a digital TV or a digital video conference system.

2. Description of the Related Art

In general, a Moving Picture Experts Group (MPEG)-2 video decoding system is provided with a transport decoder, a video decoder, a video display processor (VDP), an external memory and a host interface. The external memory may be a DRAM (Dynamic Random Access Memory) for storing an input bitstream and frames for motion compensation.

MPEG-2 standard requires a bit buffer size of 10 Mbits for supporting an MP@HL mode, at a maximum allowable bit rate of 80 Mbits/s. An existing 16 Mbits DRAM basis MPEG-2 decoder requires an external memory of approx. 96˜128 Mbits size. Therefore, price competitiveness is required in view of manufacturers and consumers. For having the price competitiveness, it is required that a good picture quality is maintained while reducing use of expensive memory. However, it is inevitable that use of additional external memories is increased in the future in light of a trend that various OSD (On Screen Display) and a variety of services are provided.

Recently, in case of a video compression and decoding system such as MPEG-2, a variety of video signals are multi-decoded and displayed for providing a variety of services when it is required that the variety of video signals are decoded by using a limited capacity of the memory. For instance, in case of a memory data bus of a general video decoding chip, STi7020 of TOMSON is 128 bits, TL850 of TERRALOGIC is 64 bits, and TM1000 of PHILLIPS is 32 bits. Especially, in order to decode two HD images, it is required to use high clock in the memory data bus of 64 bits, or to use the data bus of 128 bits.

Therefore, considering the limitation in the memory size, a price, and a bandwidth of a data bus, the video decoding device is required to be provided with an effective memory interface apparatus that can minimize the loss of a high quality picture signal. It is also required to increase processing speed of the video decoding device so as to display two HD (high definition) images or in order to support various data broadcastings, thereby it is required to decrease the data bandwidth of the external memory.

### SUMMARY OF THE INVENTION

Accordingly, the present invention is directed to a video decoding system and a memory interface apparatus that substantially obviates one or more problems due to limitations and disadvantages of the prior art.

An object of the present invention is to provide a video decoding system and a memory interface apparatus supporting a data bus of 96 bits and decreasing a memory bandwidth as well as a decoding time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a video decoding system according to the present invention includes a video decoder performing variable-length decoding (VLD), inverse quantizing (IQ), inverse discrete cosine transform (IDCT) and motion compensation (MC) for a compressed bit stream, thereby restoring the bit stream to an original image signal; an external memory simultaneously storing and outputting luminance (Y) signal and chrominance signals (Cb and Cr) of one macro block when storing the decoded video data with a data bus of 96 bits or outputting the stored data for a motion compensation; and a memory interface rearranging Y, Cb and Cr data of the decoded macro block so as to be simultaneously stored in the external memory and to be simultaneously read from the external memory.

Preferably, the memory interface composes one word with Y component of 8 pixels and Cb or Cr component of 4 pixels and controls to store and read 32 words by one external memory access.

Preferably, the memory interface for writing the macro block in the external memory includes a first Y write buffer temporarily storing Y signal of 4 pixels in a horizontal direction of a specific low of a corresponding macro block, and simultaneously outputting the Y signal, a second Y write buffer temporarily storing Y signal of next 4 pixels in a horizontal direction of a specific low of a corresponding macro block and simultaneously outputting the Y signal, a shuffler alternately rearranging input Cb and Cr chrominance signals and then outputting the rearranged Cb and Cr chrominance signals, a CbCr write buffer temporarily storing the Cb and Cr chrominance signals being alternately output from the shuffler and simultaneously outputting the Cb or Cr chrominance signals, and a memory arbiter de-multiplexing data of 32 bits which are respectively output from the first and second Y write buffers and the CbCr write buffer to data of 96 bits and then storing the data in a specific low/column address of the external memory.

Preferably, the first and second write buffers and the CbCr write buffer are dual buffers, each buffer sized in 64×32 bits.

Preferably, the memory interface further includes a video write controller controlling the first and second Y write buffers and the CbCr write buffer for generating and providing low/column address so as to write data in the external memory to the memory arbiter.

Preferably, the memory interface for reading macro blocks from the external memory includes a video read controller receiving field/frame prediction information for a motion compensation from the video decoder and generating a corresponding low/column address of the external memory, a memory arbiter reading a macro block corresponding to the low/column address output from the video read controller and outputting the result, a MUX dividing data of 96 bits output from the memory arbiter into data units of 32 bits, a first Y read buffer temporarily storing Y signal of 32 bits corresponding to 4 pixels output from the MUX and outputting the Y signal to the video decoder for the motion compensation, a second Y read buffer temporarily storing Y signal of 32 bits corresponding to next 4 pixels output from the MUX and outputting the Y signal to the video decoder for the motion compensation, a de-shuffler restoring Cb and Cr signals of 32 bits corresponding to 4 pixels, being alternately output from the MUX, to an original order, and a CbCr read buffer temporarily storing CbCr signal of 4 pixels being output from the de-shuffler and outputting the CbCr signal to the video decoder for the motion compensation.

Preferably, the video decoder performs half-pel interpolation of luminance (Y) signal output from the first and second read buffers and chrominance signals (CbCr) output from CbCr buffers in parallel.

Preferably, the first and second read buffers and the CbCr read buffer are dual buffers, each buffer sized in 64×32 bits.

In a memory interface apparatus of a video decoding system, a memory interface is connected through a data bus of 96 bits between the video decoding system and the external memory, so that decoded luminance (Y) signal and chrominance signals (Cb and Cr) of one macro block are simultaneously stored in the external memory and rearranged so as to be read simultaneously.

Preferably, the memory interface includes a first Y write/read buffer receiving decoded video data or data stored in the external memory, temporarily storing Y signal of 4 pixels in a horizontal direction of a specific low of a corresponding macro block and simultaneously outputting the Y signal, a second Y write/read buffer receiving decoded video data or data stored in the external memory, temporarily storing Y signal of next 4 pixels in a horizontal direction of a specific low of a corresponding macro block and simultaneously, outputting the Y signal, a shuffler alternately rearranging and outputting Cb and Cr, decoded video chrominance signals when storing data in the external memory, a de-shuffler arranging the Cb and Cr chrominance signals being read from the external memory in an original order and outputting the chrominance signals according to the original order when reading data from the external memory, a CbCr write/read buffer temporarily storing Cb or Cr chrominance signals of 4 pixels in a horizontal direction of a specific low of a corresponding macro block from the shuffler or de-shuffler and simultaneously outputting the Cb or Cr chrominance signals, a memory arbiter de-multiplexing data of 32 bits being respectively output from the first and second Y write/read buffers and CbCr write/read buffer and converting into data of 96 bits, storing the result in a specific low/column address of the external memory, dividing the data of 96 bits read from the specific low/column address of the external memory into data unit of 32 bits and outputting the result to the first and second Y write/read buffers and the CbCr write/read buffer, and a video write/read controller controlling the writing of the first and second Y write/read buffers and the CbCr write/read buffer, storing the data in the external memory, generating low/column address for reading the data from the external memory and then generating the low/column address to the memory arbiter.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a block diagram illustrating a video decoding system according to the present invention;

FIG. 2 is a view illustrating a column arrangement of an external memory to a macro block;

FIG. 3A to FIG. 3D are views illustrating procedures of simultaneously storing Y, Cb, Cr data of one macro block in an external memory being rearranged as shown in FIG. 2;

FIG. 4 is an exemplary view illustrating column addresses of macro blocks to low;

FIG. 5 is a block diagram illustrating a memory interface of the present invention for writing macro blocks in an external memory of a video decoder having a data bus of 96 bits; and

FIG. 6 is a block diagram illustrating a memory interface of the present invention for reading macro blocks in an external memory of a video decoder having a data bus of 96 bits.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

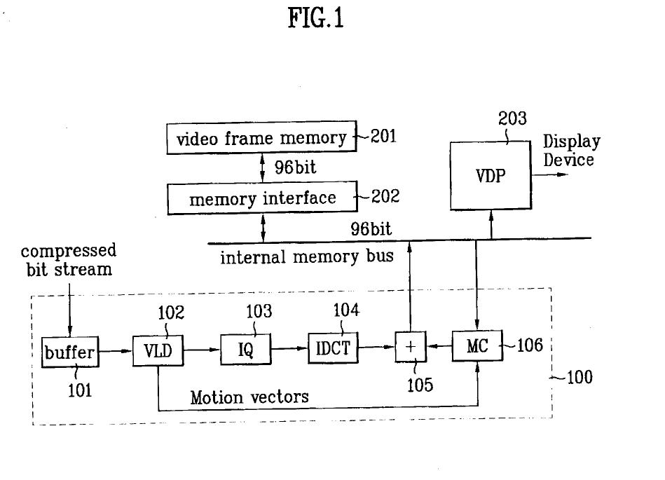

FIG. 1 is a block diagram illustrating a video decoding system according to the present invention. Referring to FIG. 1, the video decoding system according to the present invention includes a video decoder 100, an external memory 201, a memory interface 202 and a VDP 203.

At this time, the video decoder 100 performs variable length decoding (VLD), inverse quantizing (IQ), inverse discrete cosine transform (IDCT) and motion compensation (MC) for a compressed bit stream, thereby restoring the bit stream to an original image signal. The external memory 201 performs data write/read with a data bus of 96 bits, and the memory interface 202 controls simultaneously storing and reading luminance (Y) signals and chrominance (C) signals in the external memory 201 with the data bus of 96 bits. And then, a pixel value being restored to the original image signal in the video decoder 100 is stored in the external memory 201. The VDP 203 reads the pixel value being stored in the external memory 201 through the memory interface 202, so that the VDP 203 rearranges the data according to a picture type or outputs the data to a display apparatus.

In the video decoder according to the present invention, the compressed bit stream is output to a VLD 102 through a buffer of the video decoder 100. The VLD 102 performs variable length decoding of the input video bit stream, and then divides into a motion vector (MV), a quantized value and a discrete cosine transform (DCT) coefficient. In this state, the motion vector (MV) is output to a motion compensator 106, and the quantized value and DCT coefficient are output to an IQ 103. The IQ 103 inversely quantizes the DCT coefficient according to the quantized value, and output the inversely quantized value to an IDCT 104. Then, the IDCT 104 performs the inverse discrete cosine transform (IDCT) of the inversely quantized DCT coefficient, thereby outputting the result to an adder 105. If the video decoder 100 is a general MPEG-2 video decoder, the IDCT 104 performs IDCT by 8*8 block unit according to MPEG-2 video syntax.

At this time, the picture type is classified into “I”, “P” and “B” pictures in the MPEG. If the data being restored through the IDCT 104 is “I” picture, the data can be displayed in a perfect image. However, if the data being restored through the IDCT 104 is “B” or “P” picture, the data cannot be displayed in a perfect image, so that the data has to be compensated by the motion compensator 106.

That is, if “I” picture is set as a reference, the motion vector that is information indicating the motion is “0”. Meanwhile, in case of “B” and “P” pictures, the pictures have to be restored to the original image with a prior picture stored in the external memory 201. Accordingly, the motion vector 106 output from the VLD 102 is output to the motion compensator 106, and the motion compensator 106 performs motion compensation for a present pixel value with prior frames stored in the motion vector and the external memory 201, thereby outputting the result to the adder 105. That is, the motion compensator 106 predicts one direction or both directions with the prior picture stored in the external memory 201 and the motion vector of the present “B” picture or “P” picture output from the VLD 102, so that the present picture is restored to the perfect image.

The adder 105 adds the data value from IDCT to the motion compensated value, thereby calculating a final pixel value for completely restoring the present image. After that, the final pixel value is stored in the external memory 201 through the memory interface 202. That is, in case of “I” picture, the value resulted from IQ/IDCT is stored in the external memory 201. In case of “P” or “B” picture, the motion compensated data is added to the value resulted from IDCT in the adder 105, and then stored in the external memory 201.

When the memory interface 202 writes the data in the external memory 201 or reads the data stored in the external memory 201, the memory interface 202 controls to simultaneously store and read Y and CbCr signals. Accordingly, when using the data bus of 96 bits, it is possible to decrease an entire bandwidth of the video decoder, or to decrease a local processing time.

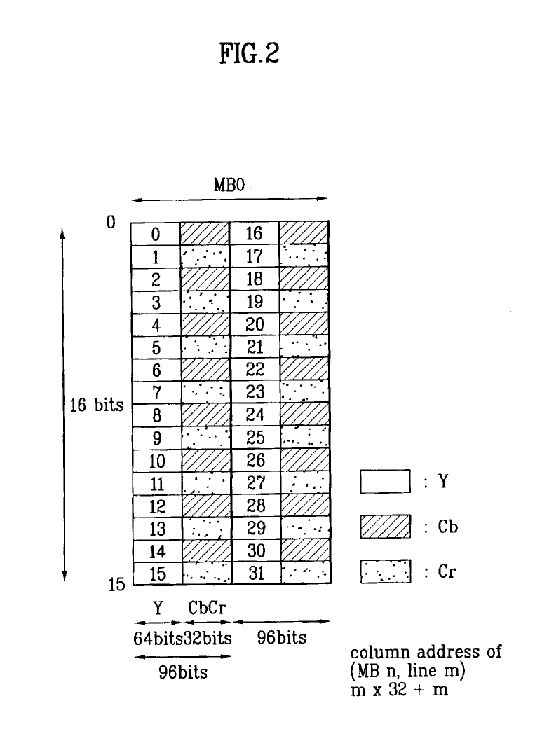

FIG. 2 is a view illustrating a column arrangement of an external memory according to a macro block. Y data of one macro block is 8×16×16 bits, and CbCr data is 8×8×8 bits. Under this state, it is important to write or read over several numbers of data at one request for reading or writing in order to improve the operation efficiency. That is, when writing one macro block in the external memory 201, data for “Y” is written which then data for “C” is written, so that latency increases due to twice external memory accesses. However, if data “Y” and “C” are arranged as shown in FIG. 2, it is possible to decrease the latency to thereby improve efficiency. Accordingly, one word is composed of “Y” component of 8 pixels, and “Cb” or “Cr” component of 4 pixels, and 32 words are simultaneously written at one request, so that it is possible to write the data of one macro block at one request for writing. The process for writing the data is performed by macro block unit, thereby improving access efficiency.

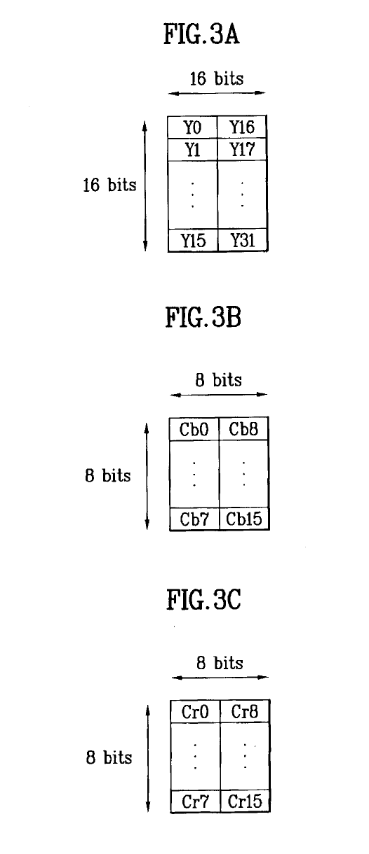

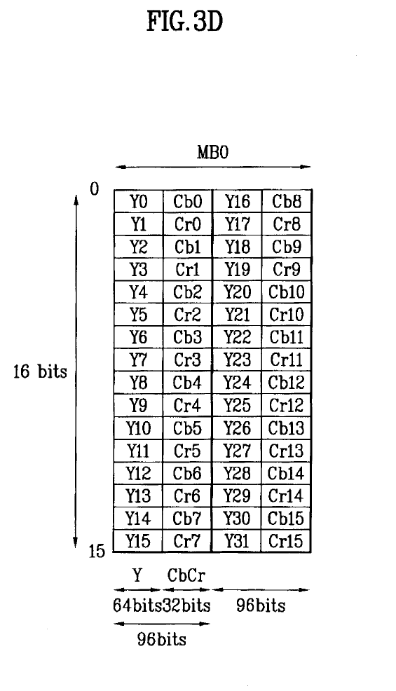

FIG. 3A to FIG. 3D are views illustrating procedures of simultaneously storing Y, Cb, Cr data of one macro block in an external memory being rearranged as shown in FIG. 2. The order for simultaneously storing Y, Cb and Cr data of one macro block may be changed.

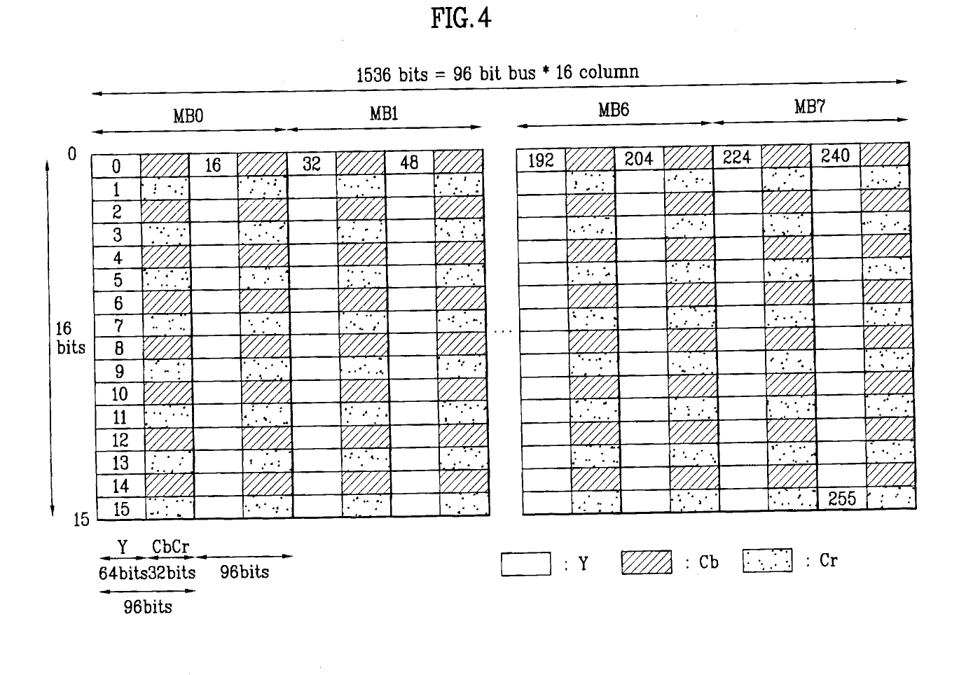

FIG. 4 is an exemplary view illustrating column addresses of macro blocks to one low. In general, 256 column addresses are allotted in one low. In a memory map of FIG. 4, 255 lows are required in one frame at HD degree (1920×1080). However, if the data bus of 64 bits is used, 391 lows are required in one frame. While comparing a certain case using the data bus of 96 bits with another case using the data bus of 64 bits, the former case increases the data bus of 32 bits, but the external memory access time decreases by half.

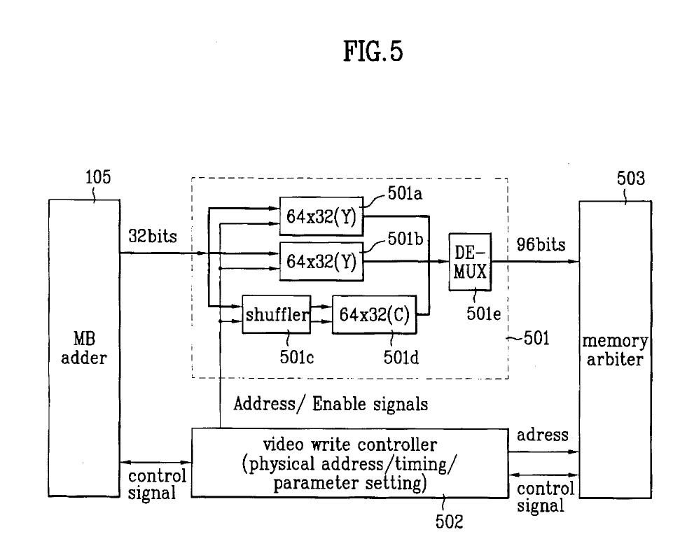

FIG. 5 is a block diagram illustrating a memory interface of the present invention for writing macro blocks in an external memory of a video decoder having a data bus of 96 bits. The data value from the IDCT is added to the motion compensated value in the adder 105, and then the output from the adder 105 is rearranged and stored in the external memory 201 as shown in FIG. 2. Referring to FIG. 5, the external memory 201 includes the memory interface 202, a video write buffer 501, a video write controller 502 and a memory arbiter 504. The video write buffer 501 uses dual buffers of 64×32 bits so as to generate the data of 96 bits.

That is, the video write buffer 501 requires two buffers 501a and 501b so as to output “Y” data of 8 pixels (one pixel is eight bits) and one buffer 501d for outputting “C” data of 4 pixels. Also, a shuffler 501c is disposed before the buffer 501d so as to alternately output “Cb” and “Cr” chrominance signals. Chrominance components of “Cb” and “Cr” signals are shuffled in the shuffler 501c and then they are sequentially arranged and stored in the buffer 501d. The data output from three buffers 501a, 501b and 501d becomes 96 bits through a DEMUX 501e and then it is output to the memory arbiter 503.

Once the the video write buffer 501 for one macro block is completed, the memory arbiter 503 performs a writing process in the external memory 201. The video write controller outputs write address and enable signals to the buffers 501a, 501b, and 501d of the video write buffer 501, receives control signals from the adder 105 and the memory arbiter 503, and sends control signals thereto. Also, the video write controller 502 outputs the write address for writing the data in the external memory 201 to the memory arbiter 503.

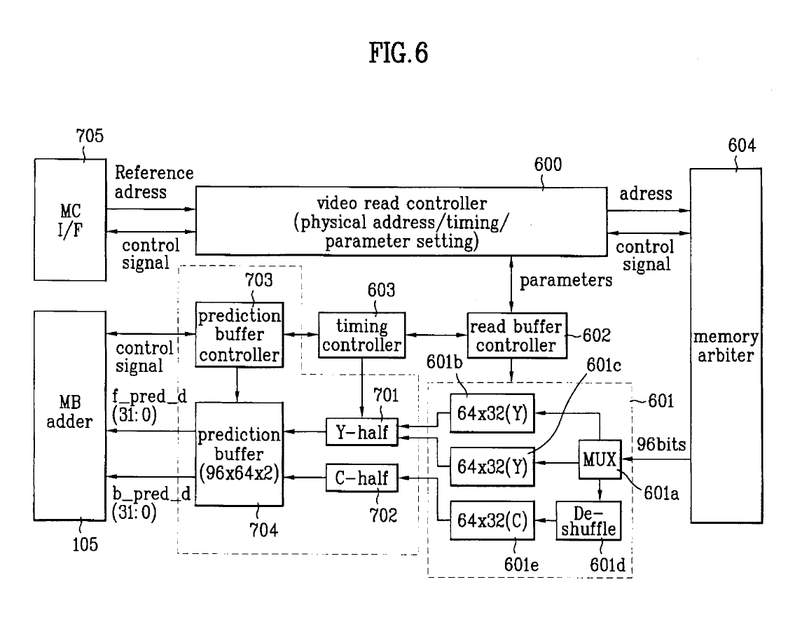

FIG. 6 is a block diagram illustrating a memory interface of the present invention for reading macro blocks in the external memory of the video decoder having a data bus of 96 bits. The motion compensator 106 of the video decoder 100 reads a predetermined portion of the external memory 201, thereby generating a macro block predicting a motion.

The memory interface 202 for reading the data from the external memory 201 is provided with a video read controller 600, a video read buffer 601, a read buffer controller 602, a timing controller 603 and a memory arbiter 604. The motion compensator 106 for compensating the motion with the data which is being read through the memory interface 202 is provided with Y half-pel interpolator 701, C-half-pel interpolator 702, a prediction buffer controller 703, a prediction buffer 704 and motion compensation interface (MC I/F) 705.

The video read controller 600 receives information for field/frame prediction from the motion compensator 106 through the motion compensation interface (MC I/F) 705 and generates corresponding low and column addresses in the external memory 201, thereby outputting the low and column addresses to the memory arbiter 604. The memory arbiter 604 reads the macro block corresponding the low and column addresses from the external memory 201 and outputs the macro block to the video read buffer 601.

The video read buffer 601 is provided with a MUX 601a, two buffers 601b and 601c and one buffer 601e. At this time, the MUX divides the data of 96 bits into data units of 32 bits. The two buffers 601b and 601c alternately stores “Y” signals being input by 32 bit-unit, while the buffer 601e stores “C” signals being input by 32 bit-unit. The “Y” signal of 8 pixels is stored in the external memory 201 so that “Y” signal is received to the buffers 601b and 601c from the external memory 201 through the MUX 601a which then the “Y” signal is stored in the buffers 601b and 601c by 4 pixel unit. Also, each buffer 601b, 601c and 601e of the video read buffer 601 is composed of a dual buffer of 64×32 bits.

A de-shuffler 601d is arranged before the buffer 601e so as to divide the color signal being output from the MUX 601a into Cb and Cr. That is, Cb and Cr, chrominance components are de-shuffled and stored in the buffer 601e. The read buffer controller 602 receives parameters from the video read controller 600 and controls write/read of the buffer 601 according to a timing signal of the timing controller 603.

At this time, as shown in FIG. 2, it is possible to read the chrominance data corresponding to “Y” component with the block address corresponding to the “Y” data, thereby restoring a desired block (Y and Cb, Cr) with one address. Then, “Cb”, “Cr” and “Y” signals of the restored block are simultaneously half-pel interpolated, and the result is stored in the prediction buffer. That is, the data of “Y” component stored in the luminance buffers 601b and 601c of the video read buffer 601 is inputted to the Y half-pel interpolator 701, while the data of “C” component stored in the color buffer 601e is inputted to the C half-pel interpolator 702. After the data of “Y” and “C” components are respectively performed in the Y half-pel interpolator 701 and C half-pel interpolator 702, the result is stored in the prediction buffer 704 according to the control of the prediction buffer controller 703. The predictive data stored in the prediction buffer 704 is output to the adder 105 reading a desired portion from the prediction buffer 704.

Accordingly, the present invention is capable of decreasing the memory access time for reading and writing CbCr in the video decoding system while comparing with the prior video decoding system which separately stores and reads Y and CbCr signals. Also, the present invention is advantageous on the memory bandwidth of an entire system, so that Y and CbCr components are simultaneously processed and a local bandwidth increases, thereby improving system efficiency. At this time, it is possible to use one buffer having video write and read functions or two buffers respectively having video write and read functions.

The video decoding system according to the present invention further comprises the following advantages.

As an essential source technology in application fields of digital TV broadcasting and video conference, implementation of a high performance video that can make multi-decoding or process a plurality of pictures is possible, thereby improving technical competition.

In the video decoding system and the memory interface thereof according to the present invention, the external memory map using the data bus of 96 bits is rearranged and the luminance and chrominance signals are simultaneously stored and read, thereby decreasing the entire bandwidth of the video decoder and the local processing time. Especially, the video decoder according to the present invention is useful for decoding the two HD (High Definition) image signals and for showingr high performance in video processing.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A video decoding system comprising:
a video decoder performing variable length decoding (VLD), inverse quantizing (IQ), inverse discrete cosine transform (IDCT) and motion compensation (MC) for a compressed bit stream, thereby restoring the bit stream to an original image signal;
an external memory simultaneously storing and outputting luminance (Y) signal and chrominance signals (Cb and Cr) of one macro block when storing the video decoded data with a data bus of 96 bits or outputting the stored data for a motion compensation; and
a memory interface rearranging Y, Cb and Cr data of the decoded macro block so as to be simultaneously stored in the external memory and to be simultaneously read from the external memory.

2. The video decoding system of claim 1, wherein the memory interface composes one word with Y component of 8 pixels and Cb or Cr component of 4 pixels and controls to store and read 32 words by one external memory access.

3. The video decoding system of claim 2, wherein the memory interface for writing the macro block in the external memory includes;
a first Y write buffer temporarily storing Y signal of 4 pixels in a horizontal direction of a specific low of a corresponding macro block and simultaneously outputting the Y signal,
a second Y write buffer temporarily storing Y signal of next 4 pixels in a horizontal direction of a specific low of a corresponding macro block and simultaneously outputting the Y signal,
a shuffler alternately rearranging input Cb and Cr chrominance signals and then outputting the rearranged Cb and Cr chrominance signals,
a CbCr write buffer temporarily storing the Cb and Cr chrominance signals being alternately output from the shuffler and simultaneously outputting the Cb or Cr chrominance signals, and
a memory arbiter de-multiplexing data of 32 bits being respectively output from the first and second Y write buffers and the CbCr write buffer and converting into data of 96 bits, and storing the data in a specific low/column address of the external memory.

4. The video decoding system of claim 3, wherein the first and second write buffers and the CbCr write buffer are dual buffers, each buffer of 64×32 bits.

5. The video decoding system of claim 3, wherein the memory interface further includes a video write controller controlling the first and second Y write buffers and the CbCr write buffer and generating and providing low/column address for writing data in the external memory to the memory arbiter.

6. The video decoding system of claim 2, wherein the memory interface for reading macro blocks from the external memory includes;
a video read controller receiving field/frame prediction information for a motion compensation from the video decoder and generating a corresponding low/column address of the external memory,
a memory arbiter reading a macro block corresponding to the low/column address output from the video read controller and outputting the result,
a MUX dividing data of 96 bits output from the memory arbiter into data units of 32 bits,
a first Y read buffer temporarily storing Y signal of 32 bits corresponding to 4 pixels output from the MUX, and outputting the Y signal to the video decoder for the motion compensation,
a second Y read buffer temporarily storing Y signal of 32 bits corresponding to next 4 pixels output from the MUX, and outputting the Y signal to the video decoder for the motion compensation,
a de-shuffler restoring Cb and Cr signals of 32 bits corresponding to 4 pixels, being alternately output from the MUX, to an original order, and
a CbCr read buffer temporarily storing CbCr signal of 4 pixels being output from the de-shuffler, and outputting the CbCr signal to the video decoder for the motion compensation.

7. The video decoding system of claim 6, wherein the video decoder performs half-pel interpolation of luminance (Y) signal output from the first and second read buffers and chrominance signals (CbCr) output from CbCr buffers in parallel.

8. The video decoding system of claim 6, wherein the first and second read buffers and the CbCr read buffer are dual buffers, each buffer of 64×32.

9. A memory interface apparatus of a video decoding system performing variable length decoding (VLD), inverse quantizing (IQ), inverse discrete cosine transform (IDCT) and motion compensation (MC) for a compressed bit stream with an external memory so as to restore the bit stream to an original image signal; wherein a memory interface is connected through a data bus of 96 bits between video decoding system and external memory, so that decoded luminance (Y) signal and chrominance signals (Cb and Cr) of one macro block are simultaneously stored in the external memory, and are rearranged so as to be simultaneously read.

10. The memory interface apparatus of claim 9, wherein the memory interface composes one word with Y component of 8 pixels, and Cb or Cr component of 4 pixels, and controls to store and read 32 words by one external memory access.

11. The memory interface apparatus of claim 9, wherein the memory interface includes;
a first Y write/read buffer receiving decoded video data or data stored in the external memory, temporarily storing Y signal of 4 pixels in a horizontal direction of a specific low to a corresponding macro block, and simultaneously outputting the Y signal,
a second Y write/read buffer receiving video decoded data or data stored in the external memory, temporarily storing Y signal of next 4 pixels in a horizontal direction of a specific low to a corresponding macro block, simultaneously, outputting the Y signal,
a shuffler alternately rearranging and outputting Cb and Cr chrominance signals when storing data in the external memory,
a de-shuffler arranging the Cb and Cr chrominance signals being read from the external memory in an original order and outputting the chrominance signals according to the original order when reading data from the external memory,
a CbCr write/read buffer temporarily storing Cb or Cr chrominance signals of 4 pixels in a horizontal direction of a specific low of a corresponding macro block from the shuffler or de-shuffler, and simultaneously outputting the Cb or Cr chrominance signals,
a memory arbiter de-multiplexing data of 32 bits being respectively output from the first and second Y write/read buffers and CbCr write/read buffer and converting into data of 96 bits, storing the result in a specific low/column address of the external memory, dividing the data of 96 bits read from the specific low/column address of the external memory into data unit of 32 bits, and outputting the result to the first and second Y writhe/read buffers and CbCr write/read buffer, and
a video write/read controller controlling write of the first and second Y write/read buffers and the CbCr write/read buffer, storing the data in the external memory, generating low/column address for reading the data from the external memory and then generating the low/column address to the memory arbiter.

12. The memory interface apparatus of claim 11, wherein the first Y write/read buffer is a dual buffer, each buffer of 64×32.

13. The memory interface apparatus of claim 11, wherein the second Y write/read buffer is a dual buffer, each buffer of 64×32.

14. The memory interface apparatus of claim 11, wherein the CbCR write/read buffer is a dual buffer, each buffer of 64×32.
